(19) United States
(12) Patent Application Publication
(10) Pub. No.: US 2026/0032340 A1
(43) Pub. Date: Jan. 29, 2026

(54) METHOD FOR ADJUSTING THE FOCUS LEVEL OF AN IMAGE OF AN OBJECT COMPRISING INTEGRATED CIRCUIT PATTERNS

(71) Applicant: Carl Zeiss SMT GmbH, Oberkochen (DE)

(72) Inventors: Bjoern Brauer, Magstadt (DE); Alexander Freytag, Erfurt (DE); Bjoern Froehlich, Jena (DE); Xuan Truong Nguyen, Berlin (DE)

(21) Appl. No.: 19/246,035

(22) Filed: Jun. 23, 2025

(30) Foreign Application Priority Data
Jul. 23, 2024 (DE) 102024120948.8

(51) Int. Cl. H04N 23/67; G01N 21/88; G01N 21/956; H04N 23/617

(52) U.S. Cl. CPC H04N 23/67; G01N 21/8851; G01N 21/95684; H04N 23/617

(57) ABSTRACT

A method for adjusting the focus level of an image of an object comprising integrated circuit patterns, the method comprising: acquiring an input image of an object comprising integrated circuit patterns using an inspection system; and applying a machine learning model to the input image, the machine learning model being trained to adjust a focus level of an input image of an object comprising integrated circuit patterns. Methods for defect detection making use of such methods for adjusting focus levels, and methods for training a corresponding machine learning model and a corresponding system for defect detection.

### CROSS-REFERENCE TO RELATED APPLICATION

This application claims benefit under 35 U.S.C. § 119(a) of German Patent Application No. 10 2024 120 948.8, filed on Jul. 23, 2024, which is incorporated herein by reference in its entirety.

### TECHNICAL FIELD

The invention relates to methods and systems for adjusting the focus level of images of objects comprising integrated circuit patterns obtained by an inspection system, in particular methods using a machine learning model. The methods and systems can be utilized for image enhancement, defect detection, quality control and process monitoring for objects comprising integrated circuit patterns, i.e., photolithography masks, reticles or wafers.

### BACKGROUND

Semiconductor manufacturing involves precise manipulation, e.g., etching, of materials such as silicon or oxide at very fine scales in the range of nm. Therefore, a quality management process comprising quality assurance and quality control is important for ensuring high quality standards of the manufactured wafers. Quality assurance refers to a set of activities for ensuring high-quality products by preventing any defects that may occur in the development process. Quality control refers to a system of inspecting the final quality of the product. Quality control is part of the quality assurance process.

A wafer made of a thin slice of silicon serves as the substrate for microelectronic devices containing semiconductor structures built in and upon the wafer. The semiconductor structures are constructed layer by layer using repeated processing steps that involve repeated chemical, mechanical, thermal and optical processes. Dimensions, shapes and placements of the semiconductor structures and patterns are subject to several influences. One of the most crucial steps is the photolithography process.

Photolithography is a process used to produce patterns on the substrate. The patterns to be printed on the surface of the substrate are generated by computer-aided-design (CAD). From the design, for each layer a photolithography mask is generated, which contains a magnified image of the computer-generated pattern to be etched into the substrate. The photolithography mask can be further adapted, e.g., by use of optical proximity correction techniques. During the printing process an illuminated image projected from the photolithography mask is focused onto a photoresist thin film formed on the substrate. A semiconductor chip powering mobile phones or tablets comprises, for example, approximately between 80 and 120 patterned layers.

Due to the growing integration density in the semiconductor industry, photolithography masks have to image increasingly smaller structures onto wafers. The aspect ratio and the number of layers of integrated circuits constantly increases and the structures are growing into 3^{rd} (vertical) dimension. The current height of the memory stacks is exceeding a dozen of microns. In contrast, the feature size is becoming smaller. The minimum feature size or critical dimension is below 10 nm, for example 7 nm or 5 nm, and is approaching feature sizes below 3 nm in near future. While the complexity and dimensions of the semiconductor structures are growing into the 3^{rd} dimension, the lateral dimensions of integrated semiconductor structures are becoming smaller. Producing the small structure dimensions imaged onto the wafer requires photolithographic masks or templates for nanoimprint photolithography with ever smaller structures or pattern elements. The production process of photolithographic masks and templates for nanoimprint photolithography is, therefore, becoming increasingly more complex and, as a result, more time-consuming and ultimately also more expensive. With the advent of EUV photolithography scanners, the nature of masks changed from transmission-based to reflection-based patterning.

On account of the tiny structure sizes of the pattern elements of photolithographic masks or templates, it is not possible to exclude errors during mask or template production. The resulting defects can, for example, arise from degeneration of photolithography masks or particle contamination. Of the various defects occurring during semiconductor structure manufacturing, photolithography related defects make up nearly half of the number of defects. Hence, in semiconductor process control, photolithography mask inspection, review, and metrology play a crucial role to monitor systematic defects. Defects detected during quality assurance processes can be used for root cause analysis, for example, to modify or repair the photolithography mask. The defects can also serve as feedback to improve the process parameters of the manufacturing process, e.g., exposure time, focus variation, etc.

Each defect in the photolithography mask can lead to unwanted behavior of the produced wafer, or a wafer can be significantly damaged. Therefore, each defect must be found and repaired if possible and necessary. Reliable and fast defect detection methods are, therefore, important for photolithography masks.

Apart from defect detection in photolithography masks, defect detection in wafers is also crucial for quality management. During the manufacturing of wafers many defects apart from photolithography mask defects can occur, e.g., during etching or deposition. For example, bridge defects can indicate insufficient etching, line breaks can indicate excessive etching, consistently occurring defects can indicate a defective mask and missing structures hint at non-ideal material deposition etc. Therefore, a quality assurance process and a quality control process are important for ensuring high quality standards of the manufactured wafers.

Aside from quality assurance and quality control, defect detection in wafers is also important during process window qualification (PWQ). This process serves for defining windows for a number of process parameters mainly related to different focus and exposure conditions in order to prevent systematic defects. In each iteration a test wafer is manufactured based on a number of selected process parameters, e.g., exposure time, focus variation, etc., with different dies of the wafer being exposed to different manufacturing conditions. By detecting and analyzing the defects in the different dies based on a quality assurance process, the best manufacturing process parameters can be selected, and a window or range can be established for each process parameter from which the respective process parameter can be selected. In addition, a highly accurate quality control process and device for the metrology of semiconductor structures in wafers is required. The recognized defects can, thus, be used for monitoring the quality of wafers during production or for process window establishment. Reliable and fast defect detection methods are, therefore, important for objects comprising integrated circuit patterns.

In order to analyze large amounts of data requiring large amounts of measurements to be taken, machine learning methods can be used. Machine learning is a field of artificial intelligence. Machine learning methods generally build a parametric machine learning model based on training data consisting of a large number of samples. After training, the method is able to generalize the knowledge gained from the training data to new previously unencountered samples, thereby making predictions for new data. There are many machine learning methods, e.g., linear regression, k-means, support vector machines, neural networks or deep learning approaches.

Deep learning is a class of machine learning that uses artificial neural networks with numerous hidden layers between the input layer and the output layer. Due to this complex internal structure the networks are able to progressively extract higher-level features from the raw input data. Each level learns to transform its input data into a slightly more abstract and composite representation, thus deriving low and high level knowledge from the training data. The hidden layers can have differing sizes and tasks such as convolutional or pooling layers.

Methods for the automatic detection of defects in objects comprising integrated circuit patterns include defect detection algorithms, which are often based on a die-to-die or die-to-database principle.

The die-to-die principle compares an acquired image of an object with another acquired image of an identical or similar object, e.g., of the same section or of another section or object containing similar structures. The discovered deviations are treated as defects.

The die-to-database principle compares an image of an object to a reference image from a database, e.g., a simulated image, a golden reference or a model of the object such as a CAD model, thereby discovering deviations from the ideal data. Unexpected patterns in the image are detected due to large differences and are treated as defects.

Both die-to-die and die-to-database approaches, rely on a comparison of images, e.g., acquired images and/or simulated images. However, to detect defects with high accuracy and sensitivity, high-quality images are required, which can be difficult to generate, in particular for EUV systems. The image quality is strongly influenced by the focus level of the images. For example, images could be defocused due to an inaccurate placement of the stage of the inspection system during image acquisition. Furthermore, some patterns may require a pattern-dependent focus that is difficult to implement using autofocus and can easily lead to defocused parts of the image. Local height profile deviations of the photolithography mask as well as imprecise stage movements can also lead to defocus of the acquired images. Apart from the focus level, the image quality can be affected further, e.g., by noise, contrast or brightness variations or shadowing effects due to different EUV beam configurations.

Therefore, it is an aspect of the invention to improve the quality of images of objects comprising integrated circuit patterns. In particular, it is an aspect of the invention to adjust the focus level of an image of an object comprising integrated circuit patterns automatically and with high accuracy. It is also an aspect of the invention to adjust the focus level of an image of an object comprising integrated circuit patterns requiring low computation times. It is another aspect of the invention to improve the accuracy and sensitivity of defect detection methods for objects comprising integrated circuit patterns.

The aspects are achieved by the invention specified in the independent claims. Advantageous embodiments and further developments of the invention are specified in the dependent claims.

### SUMMARY

Embodiments of the invention concern methods and systems for improving the image quality, in particular the focus level, of an image of an object comprising integrated circuit patterns.

A first embodiment involves a computer implemented method for adjusting the focus level of an image of an object comprising integrated circuit patterns, the method comprising: acquiring an input image of an object comprising integrated circuit patterns using an inspection system; and applying a machine learning model to the input image, the machine learning model being trained to adjust a focus level of an input image of an object comprising integrated circuit patterns.

By adjusting the focus level of the acquired input image, the image quality is improved without having to acquire another image of the same object at a different focus level. In this way, the processing time is reduced. Furthermore, it is often not possible to take a second image of an object during the production cycle, since the object moves on to another stage. By using a machine learning model for adjusting the focus level of the input image, the focus level is adjusted automatically. Furthermore, the focus level is adjusted quickly as the inference step of a machine learning model usually only requires a single forward pass of the input data. Finally, using a machine learning model for adjusting the focus level yields highly accurate focus-adjusted images, since machine learning models directly derive all important information from training data instead of using rules defined by humans that usually do not cover special cases or do not use all underlying information available to the task.

An object comprising integrated circuit patterns can refer, for example, to a photolithography mask, a reticle or a wafer. In a photolithography mask or reticle the integrated circuit patterns can refer to mask structures used to generate semiconductor patterns in a wafer during the photolithography process. In a wafer the integrated circuit patterns can refer to semiconductor structures, which are imprinted on the wafer during the photolithography process.

The term “inspection system” refers to a system that is configured to inspect objects comprising integrated circuit patterns, e.g. photolithography masks or wafers, by taking an image of the object and detecting defects in the image. In case of a photolithography mask, an inspection system can, for example, be a mask review system or a mask repair system. In particular, inspection systems comprise actinic photolithography mask inspection systems. In case of a wafer, an inspection system can, for example, be a brightfield or darkfield microscopy tool or an electron beam wafer inspection tool or a focused ion beam scanning electron microscopy (FIB-SEM) tool.

In case of the object being a photolithography mask, the photolithography mask may have an aspect ratio of between 1:1 and 1:4, preferably between 1:1 and 1:2, most preferably of 1:1 or 1:2. The photolithography mask may have a nearly rectangular shape. The photolithography mask may be preferably 5 to 7 inches long and wide, most preferably 6 inches long and wide. Alternatively, the photolithography mask may be 5 to 7 inches long and 10 to 14 inches wide, preferably 6 inches long and 12 inches wide.

An image or input image or reference image of an object comprising integrated circuit patterns can refer to various kinds of images of the object, e.g., a two-dimensional image, a three-dimensional image, a stack of images or a volumetric three-dimensional image that can, for example, be processed slice by slice. An image can be acquired using an inspection system, or it can be simulated, e.g., from a design of the photolithography mask. Images can be of various modalities, e.g., structured electron microscopy (SEM) images, aerial images, optical images, x-ray images, computer tomography (CT) images, focused-ion-beam (FIB) images, atomic force microscopy (AFM) images, ultrasound images or multimodal images, e.g., acquired using a combination of x-ray imaging and SEM. An image of an object comprising integrated circuit patterns can image the complete object or one or more subsections thereof.

The input image may comprise an image acquired using the inspection system and/or the reference image.

An aerial image of a photolithography mask indicates the radiation intensity distribution of the photolithography system in a wafer plane. The aerial image, thus, simulates the structures on the surface of a wafer when printing the wafer using the photolithography mask in the inspection system. A wafer plane refers to a plane within the resist on top of the wafer in a photolithography system. An aerial image can be acquired using an inspection system and a photolithography mask. An aerial image can be simulated using a design of a photolithography mask and an aerial image simulation method such as the rigorous coupled wave analysis (RCWA) method or the thin element approximation (TEA) method.

According to an example of the first embodiment, the machine learning model is trained to adjust the focus level of the input image to a specified target focus level. Instead of adjusting the focus level to optimize some image quality measure, a single target focus level can be predefined for all input images, or a target focus level can be specified for each input image separately. In this way, the machine learning model can be flexibly adapted to different application requirements. For example, a user can determine the target focus level, or images with a desired defocus can be generated, e.g., for training purposes.

According to an aspect of the example, the focus level of a reference image is determined, and the target focus level is derived from the focus level of the reference image. In this way, the target focus level of the input image can be adjusted with respect to the focus level of a reference image, e.g., improving the comparability of the input image and the reference image or the image quality of the input image.

According to an aspect of the example, the target focus level is provided as an additional input to the machine learning model. This improves the accuracy and applicability of the machine learning model.

In an example of the first embodiment, the focus level of the input image is adjusted using an image quality measure. In this way, the focus level can be adjusted automatically and with respect to some predefined image quality measure to optimize the image quality.

In an example of the first embodiment, the focus level of the input image is provided as an additional input to the machine learning model. Measuring a focus level of an input image is much simpler than modifying a focus level of an input image. Thus, valuable additional information about the input image is exploited and provided to the machine learning model, thereby simplifying the training and increasing the accuracy of the predicted focus-adjusted images.

According to an example, a design of a photolithography mask is provided as an additional input to the machine learning model. The design helps to resolve ambiguities and, thus, improves the prediction accuracy of the machine learning model.

In an example, the machine learning model is trained to remove additional image quality degradations from the input image, e.g., a focus-specific misalignment. In this way, the quality of the predicted focus-adjusted images is further improved.

According to an example of the first embodiment of the invention, the machine learning model comprises an encoder-decoder architecture, in particular a U-Net architecture. An encoder-decoder architecture such as a U-Net transforms an input image to an output image using an encoder and a decoder, thereby extracting the most relevant information for the task. Thus, the accuracy of the predicted focus-adjusted images is improved.

According to an aspect of the example, the focus level of the input image is provided as an additional input to the encoder-decoder architecture in one of its hidden layers, in particular in one of the encoder layers, in particular in the bottleneck. This allows for a particularly simple and efficient processing of the additional information compared to adding the additional information to the input of the machine learning model.

According to an aspect of the example, a target focus level of the input image is provided as an additional input to the encoder-decoder architecture in one of its hidden layers, in particular in one of the decoder layers, in particular in the bottleneck. This allows for a particularly simple and efficient processing of the additional information compared to adding the additional information to the input of the machine learning model.

In an example of the first embodiment of the invention, the machine learning model comprises a conditional diffusion model that sequentially reverts a stochastic process and that is trained to increase a focus level of the input image in each stochastic process step or that is trained to decrease a focus level of the input image in each stochastic process step. Due to their iterative nature, diffusion models can perform complex tasks in a highly accurate way and are more stable than one-step approaches that carry out image-to-image transformations in a single step. Due to the use of conditional information, conditional diffusion models yield more accurate and task-specific results than standard diffusion models.

According to a preferred example of the first embodiment of the invention, a reference image of the object comprising integrated circuit patterns is provided as an additional input to the machine learning model, and the machine learning model is trained to adjust at least one of the focus level of the input image and the focus level of the reference image such that the focus levels approximately match, or such that the focus levels match. Thus, only the focus level of the input image is adjusted to (approximately) match the focus level of the reference image, or only the focus level of the reference images is adjusted to (approximately) match the focus level of the input image, or both the focus level of the input image and the focus level of the reference image are adjusted to (approximately) the same focus level that is different from the focus level of the input image and from the focus level of the reference image. In this way, the focus levels of the input image and the reference image can be matched and optimized at the same time, for example, using an image quality measure. This improves the comparability of both images, e.g., in a die-to-die or die-to-database defect detection method. At the same time, the image quality can be optimized.

An alternative method for adjusting the focus level of an image of an object comprising integrated circuit patterns according to the first embodiment of the invention comprises: acquiring an input image of an object comprising integrated circuit patterns using an inspection system; determining the focus level of the acquired input image; selecting a machine learning model from a set of machine learning models using the determined focus level, wherein each machine learning model of the set of machine learning models is trained to adjust the focus level of an input image of an object comprising integrated circuit patterns for an input image of a focus level within a specific focus level interval; applying the selected machine learning model to the input image. By training a set of machine learning models that are specialized with respect to specific focus level intervals, the machine learning models are easier to train and yield predictions of higher accuracy as the learning task is less complex due to the specialization.

An alternative method for adjusting the focus level of an image of an object comprising integrated circuit patterns according to the first embodiment of the invention comprises: acquiring an input image of an object comprising integrated circuit patterns using an inspection system; applying two or more machine learning models from a set of machine learning models to the acquired input image yielding a set of focus-adjusted images, wherein each machine learning model of the set of machine learning models is trained to adjust the focus level of an input image of an object comprising integrated circuit patterns for an input image of a focus level within a specific focus level interval; selecting a focus-adjusted image from the set of focus-adjusted images using an image quality measure. By training a set of machine learning models that are specialized with respect to specific focus level intervals, the machine learning models are easier to train and yield predictions of higher accuracy, as the learning task is less complex due to the specialization. The image quality of the focus-adjusted image is also improved due to the selection with respect to the image quality measure.

A method for detecting defects in an image of an object comprising integrated circuit patterns according to a second embodiment of the invention comprises: acquiring an input image of an object comprising integrated circuit patterns using an inspection system; adjusting the focus level of the input image using a method according to any one of the preceding claims; and applying a defect detection method to the focus-adjusted input image to detect defects. Preferably, the defect detection method comprises a machine learning model for defect detection. Due to the focus-adjustment of the input image the quality of the input image is improved, and defects can be detected with higher accuracy and sensitivity.

The term “defect” refers to a localized deviation of an integrated circuit pattern from an a priori defined norm of the integrated circuit pattern. For instance, a defect of an integrated circuit pattern, e.g., of a semiconductor structure, can result in malfunctioning of an associated semiconductor device. Depending on the detected defect, for example, the photolithography process can be improved, or photolithography masks or wafers can be repaired or discarded. The norm of the structure or pattern can be defined by one or more corresponding reference photolithography masks or reference datasets, e.g., by design datasets, simulated datasets or acquired defect-free datasets.

A method for detecting defects in an image of an object comprising integrated circuit patterns according to a second embodiment of the invention comprises: acquiring an input image of an object comprising integrated circuit patterns using an inspection system; obtaining a reference image of the object comprising integrated circuit patterns; adjusting at least one of the focus level of the input image and the focus level of the reference image such that the focus levels approximately match, or such that the focus levels match, using a method according to claim 13 or 14; and applying a defect detection method to the focus-adjusted input image and the focus-adjusted reference image. Due to the focus-adjustment of the input image and reference image the image quality is comparable and improved, and defects can be detected with higher accuracy and sensitivity in a die-to-die or die-to-database approach. The reference image can, for example, refer to an acquired image of the same or a different object comprising integrated circuit patterns (die-to-die) or to a simulated image of the object comprising integrated circuit patterns, e.g., from a CAD model, or to a golden reference (die-to-database).

According to a third embodiment of the invention, a computer implemented method for training a machine learning model for adjusting the focus level of an image of an object comprising integrated circuit patterns, preferably a machine learning model according to the second embodiment of the invention, comprises: obtaining training data comprising pairs of out-of-focus images of objects comprising integrated circuit patterns and corresponding in-focus images obtained by adjusting the focus level of the out-of-focus images; and training the machine learning model to adjust the focus level of an input image of an object comprising integrated circuit patterns using the training data. In this way, the training of the machine learning model can be accomplished efficiently and yields highly accurate predictions. The term “in-focus image” refers to an image without defocus, i.e., an image in focus, or an image whose focus level corresponds to a target focus level. The term “out-of-focus image” refers to an image with defocus, whose focus level is not optimal with respect to some image quality measure or does not correspond to a target focus level.

According to an example of the third embodiment of the invention, the machine learning model is trained by minimizing a loss function that comprises an adjustment loss function that measures the deviation of focus-adjusted images predicted by the machine learning model when presented with out-of-focus images of the training data, from the corresponding in-focus images of the training data. In this way, the prediction accuracy of the trained machine learning model is improved.

According to an example or aspect, the machine learning model is trained by minimizing a loss function that comprises an adversarial loss function that measures the distance between a distribution of focus-adjusted images predicted by the machine learning model when presented with out-of-focus images of the training data, and a distribution of the corresponding in-focus images. In this way, the machine learning model learns to imitate focus-adjusted images with high accuracy, thereby improving the prediction accuracy of the trained machine learning model and the training speed.

In an example, the machine learning model is trained by minimizing a loss function that comprises an adjustment loss function and an adversarial loss function. In this way, the focus-adjusted images have an appearance of acquired focus-adjusted images following the learned distribution of focus-adjusted images.

For training a machine learning model for focus adjustment and a machine learning model for defect detection according to the second embodiment of the invention, a joint loss function can be used.

A computer implemented method for training a machine learning model for adjusting the focus level of an image of an object comprising integrated circuit patterns and a machine learning model for defect detection in an image of an object comprising integrated circuit patterns according to the second embodiment of the invention uses a joint loss function to train the machine learning model for adjusting the focus level of an image and the machine learning model for defect detection jointly.

The machine learning model for focus adjustment and the machine learning model for defect detection can, for example, be trained by minimizing a joint loss function that comprises an adjustment loss function and/or an adversarial loss function and a defect detection loss function. In this way, the focus is adjusted as indicated by the in-focus images and/or the appearance of the focus-adjusted images follows the learned distribution. At the same time the focus-adjusted images are well suited for defect detection and the machine learning model for defect detection is adapted to the focus-adjusted images.

A fourth embodiment of the invention relates to a computer-readable medium, on which a computer program executable by a computing device is stored, the computer program comprising code for executing a method according to the third embodiment of the invention.

A fifth embodiment of the invention relates to a computer program product comprising instructions which, when the program is executed by a computer, cause the computer to carry out a method according to the third embodiment of the invention.

An inspection system for detecting defects in an object comprising integrated circuit patterns according to a sixth embodiment of the invention comprises: an imaging device configured to provide an image of the object comprising integrated circuit patterns; one or more processing devices; one or more machine-readable hardware storage devices comprising instructions that are executable by one or more processing devices to perform operations comprising any one of the methods for detecting defects in an image of an object comprising integrated circuit patterns according to the second embodiment of the invention.

The invention described by embodiments, examples and aspects is not limited to the embodiments, examples and aspects, but can be implemented by those skilled in the art by various combinations or modifications thereof.

### BRIEF DESCRIPTION OF DRAWINGS

FIG. 1 illustrates an exemplary transmission-based photolithography system, e.g., a deep ultraviolet (DUV) photolithography system;

FIG. 2 illustrates an exemplary reflection-based photolithography system, e.g., an extreme ultraviolet (EUV) photolithography system;

FIG. 3 shows an image of an object comprising integrated circuit patterns in the form of a photolithography mask comprising a defect;

FIG. 4 shows a flowchart illustrating the steps of a method for adjusting the focus level of an image of an object comprising integrated circuit patterns according to a first embodiment of the invention;

FIG. 5 illustrates the method for adjusting the focus level of an image of an object comprising integrated circuit patterns according to the first embodiment of the invention;

FIG. 6 illustrates a machine learning model in the form of an encoder-decoder architecture, here a U-Net, that is used for adjusting the focus level of an image of an object comprising integrated circuit patterns and that can process additional information provided;

FIG. 7 illustrates a variant of the machine learning model for focus-adjustment that receives an input image and a reference image and adjusts the focus level of the input image to that of the reference image or that adjusts the focus level of the reference image to that of the input image or that adjusts both the focus level of the input image and the focus level of the reference image to the same focus level;

FIG. 8 illustrates a machine learning model in the form of a conditional diffusion model for adjusting the focus level of an image of an object comprising integrated circuit patterns;

FIG. 9 illustrates a flowchart of a method for adjusting the focus level of an image of an object comprising integrated circuit patterns using a set of specialized machine learning models;

FIG. 10 shows a normal density function approximating a statistic over frequencies of focus levels that is used for defining focus level intervals;

FIG. 11 illustrates a flowchart of a method for adjusting the focus level of an image of an object comprising integrated circuit patterns using a set of specialized machine learning models without determining the focus level of the input image;

FIG. 12 shows a flowchart of a method for detecting defects in an image of an object comprising integrated circuit patterns according to a second embodiment of the invention;

FIG. 13 shows a flowchart of a method for detecting defects in an image of an object comprising integrated circuit patterns using a reference image according to a second embodiment of the invention; and

FIG. 14 illustrates the construction of a suitable loss function for training a machine learning model for focus adjustment, in particular an encoder-decoder CNN;

FIG. 15 illustrates the construction of a suitable loss function for jointly training a machine learning model for focus adjustment and a machine learning model for defect detection;

FIG. 16 illustrates the application of a trained machine learning model for focus adjustment and a trained machine learning model for defect detection to an out-of-focus image;

FIG. 17 illustrates a system for detecting defects in an object comprising integrated circuit patterns according to a sixth embodiment of the invention.

### DETAILED DESCRIPTION

In the following, advantageous exemplary embodiments of the invention are described and schematically shown in the figures. Throughout the figures and the description, same reference numbers are used to describe same features or components. Dashed lines indicate optional features.

The methods and systems herein can be used to inspect images of a variety of photolithography systems, e.g., transmission-based photolithography systems 10 or reflection-based photolithography systems 10′.

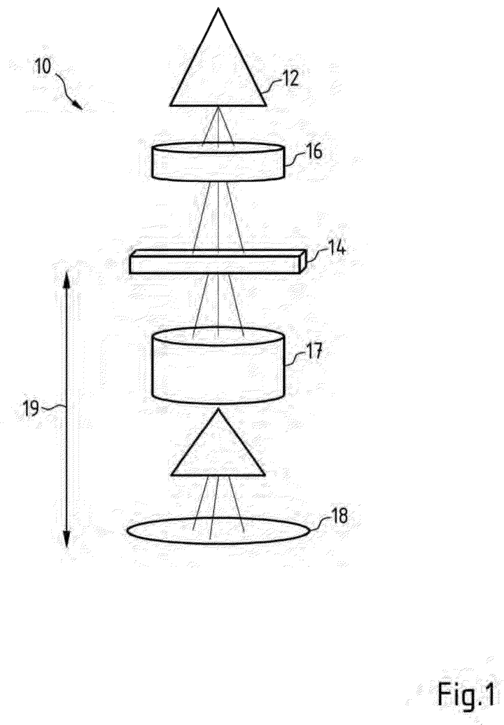

FIG. 1 illustrates an exemplary transmission-based photolithography system 10, e.g., a DUV photolithography system. Major components are a radiation source 12, which may be a deep-ultraviolet (DUV) excimer laser source, imaging optics which, for example, define the partial coherence and which may include optics that shape radiation from the radiation source 12, a photolithography mask 14, illumination optics 16 that illuminate the photolithography mask 14 and projection optics 17 that project an image of the photolithography mask model 92, e.g., the design pattern, onto a wafer plane 18. An adjustable filter or aperture at the pupil plane of the projection optics 17 may restrict the range of beam angles that impinge on the wafer plane 18, where the largest possible angle defines the numerical aperture of the projection optics NA=n sin(Gmax), wherein n is the refractive index of the media between the substrate and the last element of the projection optics 17, and Gmax is the largest angle of the beam exiting from the projection optics 17 that can still impinge on the wafer plane 18.

In the present document, the terms “radiation” or “beam” are used to encompass all types of electromagnetic radiation, including ultraviolet radiation (e.g. with a wavelength of 365, 248, 193, 157 or 126 nm) and EUV (extreme ultra-violet radiation, e.g. having a wavelength in the range of about 3-100 nm).

Illumination optics 16 may include optical components for shaping, adjusting and/or projecting radiation from the radiation source 12 before the radiation passes the photolithography mask 14. Projection optics 17 may include optical components for shaping, adjusting and/or projecting the radiation after the radiation passes the photolithography mask 14. The illumination optics 16 exclude the light source 12, the projection optics exclude the photolithography mask 14.

Illumination optics 16 and projection optics 17 may comprise various types of optical systems, including refractive optics, reflective optics, apertures and catadioptric optics, for example. Illumination optics 16 and projection optics 17 may also include components operating according to any of these design types for directing, shaping or controlling the projection beam of radiation, collectively or singularly.

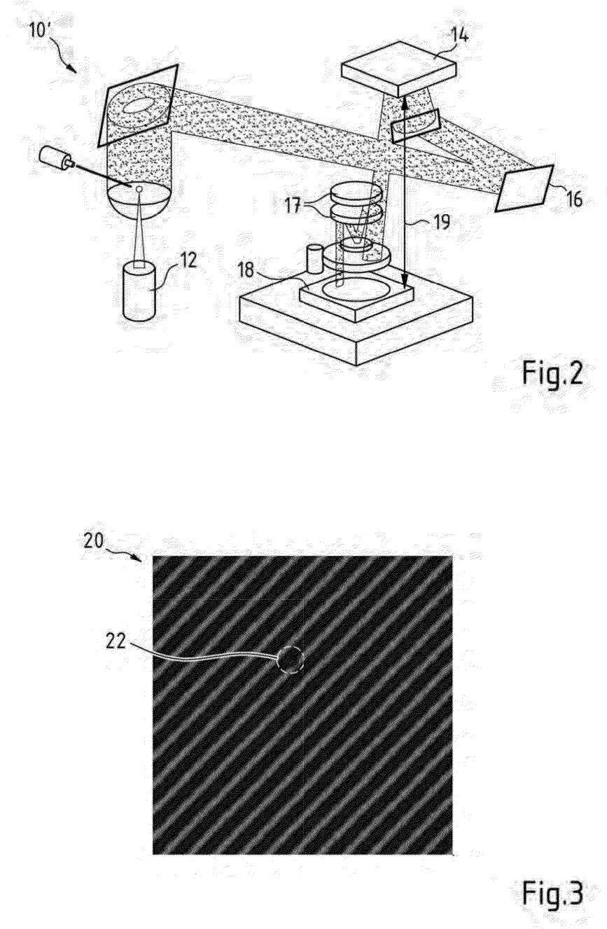

FIG. 2 illustrates an exemplary reflection-based photolithography system 10′, e.g., an extreme ultraviolet light (EUV) lithography system. Major components are a radiation source 12, which may be a laser plasma light source, illumination optics 16 which, for example, define the partial coherence and which may include optics that shape radiation from the radiation source 12, a photolithography mask 14, and projection optics 17 that project an image of the photolithography mask model 92, the design pattern, onto a wafer plane 18. An adjustable filter or aperture at the pupil plane of the projection optics 17 may restrict the range of beam angles that impinge on the wafer plane 18, where the largest possible angle defines the numerical aperture of the projection optics NA=n sin(Gmax), wherein n is the refractive index of the media between the substrate and the last element of the projection optics 17, and Gmax is the largest angle of the beam exiting from the projection optics 17 that can still impinge on the wafer plane 18.

FIG. 3 illustrates an image 20 of a photolithography mask 14 that contains a defect 22. According to the techniques described herein, various imaging modalities may be used to acquire the image 20. Images 20 can comprise single-channel images or multi-channel images, e.g., focus stacks. For instance, it is possible that the image includes 2-D images. It is possible to employ a multi beam scanning electron microscope (mSEM). mSEM employs multiple beams to acquire contemporaneously images in multiple fields of view. For instance, a number of not less than 50 beams could be used or even not less than 90 beams. Each beam covers a separate portion of a surface of the photolithography mask. Thereby, a large image is acquired within a short duration of time. Typically, contemporary machines acquire 4.5 gigapixels per second. Other examples for images including 2D images relate to imaging modalities such as optical imaging, phase-contrast imaging, x-ray imaging, etc. It is also possible that the image is a volumetric 3-D dataset, which can be processed slice-by-slice or as a three-dimensional volume. Here, a crossbeam imaging system including a focused-ion beam (FIB) source, an atomic force microscope (AFM) or a scanning electron microscope (SEM) could be used. Furthermore, magnetic resonance (MR) images, ultrasound images or computed tomography (CT) images could be used. Multimodal images may be used, e.g., a combination of x-ray imaging and SEM. The image can be an aerial image acquired by an aerial image measurement system. An aerial image is the radiation intensity distribution at substrate level. It can be used to simulate the radiation intensity distribution generated by a photolithography mask during the photolithography process. The aerial image measurement system can, for example, be equipped with a staring array sensor or a line-scanning sensor or a time-delayed integration (TDI) sensor.

Due to inaccuracies in the image acquisition process, e.g., inaccurate stage movements, variable height profiles of the integrated circuit pattern, or pattern-dependent foci, the focus level of the acquired image can be suboptimal. Thus, the image quality can be improved by adjusting the focus level of the image.

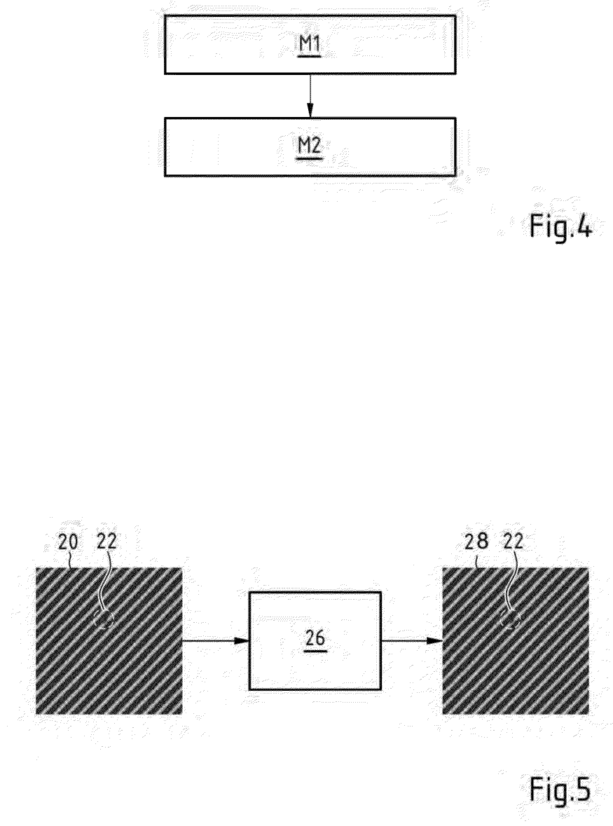

To this end, a method for adjusting the focus level of an image of an object comprising integrated circuit patterns according to a first embodiment of the invention is illustrated in FIG. 4. The method comprises: acquiring an input image of an object comprising integrated circuit patterns using an inspection system in a step M1; and applying a machine learning model to the input image, the machine learning model being trained to adjust a focus level of an input image of an object comprising integrated circuit patterns in a step M2.

FIG. 5 illustrates the computer implemented method 24 for adjusting the focus level of an image 20 of an object comprising integrated circuit patterns according to the first embodiment of the invention. The focus level may refer to the focal distance of the system used to acquire the image. By adjusting the focus level, the focus may be set to a particular z distance. The focus level may be measured, for example, in mm or nm. A focus level may, for example, be z=z0 initially. After adjusting the focus level, the adjusted focus level may, for example, be z=z0+5 nm. A focus level may be increased by increasing the focal distance, e.g., by increasing z. A focus level may be decreased by decreasing the focal distance, e.g., by decreasing z. An input image 20 is acquired using an inspection system. The input image 20 is used as input of a machine learning model 26. The machine learning model 26 is trained to adjust the focus level of the input image 20 yielding a focus-adjusted image 28. The focus-adjustment leads to an improved contrast of the structures in the image and, thus, improves the detectability of defects 22. The machine learning model 26 may be trained to adjust the focus level by a specific amount e.g., by changing the focal distance from z0 to z0 +d1, where d1 is predetermined, or to a specific target focus level, e.g., by changing the focal distance from z0 to a predetermined z_target, or it may be trained to optimize the focus level with respect to some image quality measure such as the contrast of the image. For example the change of the focal distance may vary depending on the image, e.g., one image may require the focus level to change 10 nm in the z distance, another image may require the focus level to change −5 nm in the z-distance.

The method can be used to adjust the focus level of an image to an optimized focus level. The optimality can, for example, be measured using some image quality measure. or a combination of image quality measures. An image quality measure can, for example, comprise an average contrast of an image, an average edge contrast, an amount of high frequencies (e.g., frequencies above some defined threshold) in Fourier or Wavelet space, a structural similarity index measure (SSIM), a signal to noise ratio (SNR), a statistical measure such as an intensity variance or a measure of a histogram of intensities of the image, a response of a machine learning model that is trained to measure the quality of an image, etc. An image quality measure can also be specifically designed to measure the detectability of one or more specific defect types, in particular, compared to non-defective regions or compared to other defect types. Thus, the machine learning model can be trained to adjust the focus level of an input image to improve the detectability of specific defect types, e.g., the contrast or brightness.

The method can also be used to adjust the focus level of an image to a target focus level. The target focus level may refer to a predetermined focus level, i.e., a predetermined z distance. In this case, the training images used for training the machine learning model for focus-adjustment may comprise out-of-focus images and corresponding in-focus images of the target focus level.

In some implementations, the average contrast of an image is used as quality measure. In this case, the machine learning model for focus-adjustment is trained to adjust the focus level of the input image to some focus level that improves the average contrast of the input image. To this end, training data is used for training the machine learning model for focus-adjustment, the training data comprising out-of-focus images and corresponding in-focus images of different focus levels with an improved average contrast with respect to the out-of-focus image. To adjust the focus-level of an image, the system takes an image of the object and applies the trained machine learning model for focus-adjustment to the image. The output image of the machine learning model will then have some adjusted focus level and an increased average image contrast.

In some implementations, an SSIM, an SNR, a statistical measure or a machine learning model response of an image is used as quality measure. In this case, the machine learning model for focus-adjustment is trained to adjust the focus level of the input image to some focus level that improves the SSIM, SNR, statistical measure or machine learning model response of the input image. To this end, training data is used for training the machine learning model for focus-adjustment, the training data comprising out-of-focus images and corresponding in-focus images of different focus levels with an improved SSIM, SNR, statistical measure or machine learning model response. To adjust the focus-level of an image, the system takes an image of the object and applies the trained machine learning model for focus-adjustment to the image. The output image of the machine learning model will then have some adjusted focus level and an increased SSIM.

To generate training images comprising out-of-focus images and in-focus images, physical adjustments of the one or more systems used to acquire the training images are made. To modify the focus level of an image, the stage holding the object or the objective lens of the system or both may be moved along the z-axis. The stage and the objective lens may be moved using drives or motors. In a wafer inspection system, the motor used for focusing is often part of a z-axis actuator within a multi-axis stage. These actuators are responsible for adjusting the distance between the objective lens (or other imaging components) and the object surface during the scanning of the object.

According to an example, the machine learning model is trained to adjust the focus level of the input image to a specified target focus level. The machine learning model can be trained to adjust any input image to the same specified target focus level. In this case, the majority of training images contains in-focus images of the target focus level. The target focus level can, for example, be specified by a user, it can be obtained from a database or it can be measured in a reference image. The target focus level can be an optimized focus level with respect to some image quality measure. The targe focus level can also be a suboptimal focus level used to generate defocus images.

In an example, a reference image is provided, the focus level of the reference image is determined, and the target focus level is derived from the focus level of the reference image. The focus level of the reference image can, for example, be measured. The target focus level can be set to the focus level of the reference image, or it can be computed from the focus level of the reference image using some calculation rule, e.g., twice the focus level of the reference image. The focus level of the input image can, for example, be approximately matched or matched to the focus level of the reference image. In this way, the comparability of the input image and the reference image is improved. Furthermore, the image quality of the reference image that strongly depends on the focus level can also be obtained in the input image.

The target focus level can also vary for each input image. It can be used as an additional input of the machine learning model, such that the target focus level is image-specific, i.e., vary with the input image. The target focus level can, for example, be specified by a user for the input image, it can be obtained from a database, or it can be measured in a reference image. The target focus level can be an optimized focus level with respect to some image quality measure. The target focus level can also be a suboptimal focus level used to generate defocus images.

Measuring the focus level of an image is, in fact, much simpler than adjusting the focus level of the image. The focus level of an image can be measured using, for example, an interferometer that measures the distance between photolithography mask and sensor. Alternatively, time of flight sensors or tactile sensors could be used to measure the distance between photolithography mask and sensor. Alternatively, the focus level of an image can be derived from the contrast of the image using gradients or convolutions with Sobel filters as, for example, described in US 2022/0405903.

According to an example, a design of a photolithography mask is provided as an additional input 30 to the machine learning model 26. In case the object comprising integrated circuit patterns is a photolithography mask, the design of the photolithography mask can be provided. In case the object comprising integrated circuit patterns is a wafer, the design of the photolithography mask used to manufacture the wafer can be provided. The design can be used to resolve ambiguities in a defocused input image. The defocused input image is usually blurred and/or of a lower contrast leading to a loss of information. Therefore, there is no unique mapping from a defocused input image to a corresponding focused image. There can be multiple focused images that could lead to the same defocused input image. To obtain a unique solution, i.e., a unique focused image from the defocused input image, the design of the photolithography mask can be used as additional source of information. For example, in case the defocused input image contains a blob, i.e., a roundish, blurry object that does not contrast sharply with the background, and the design of the photolithography mask contains a triangle in the same location, then the focused image should also contain a triangle in this location. Thus, using the design of the photolithography mask, the machine learning model can be trained to resolve ambiguities in the defocused input image.

The design can, for example, be provided as a rasterized image.

In a preferred example, a focus level of the input image 20 is provided as additional input 30 to the machine learning model 26. The focus level of the input image 20 can, for example, be specified by a user, it can be obtained from a database, or it can be measured in the input image 20.

Different machine learning models can be used for focus-adjustment, e.g., deep learning models, encoder-decoder architectures, CNNs, U-Nets, Transformers,

Diffusion models, etc. Preferably, deep learning models are used as machine learning model for focus-adjustment to achieve a high accuracy of the predictions of the machine learning model.

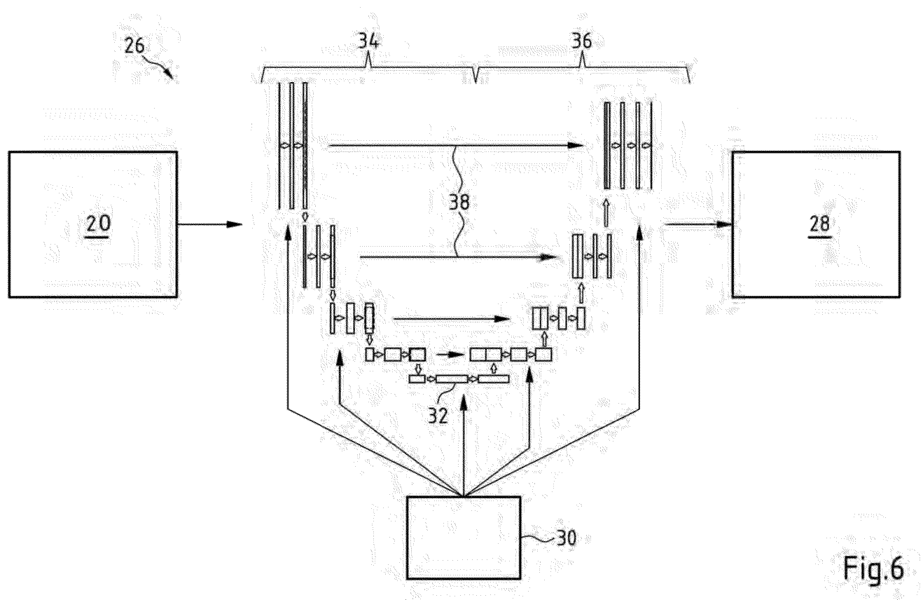

In FIG. 6, the input image 20 is used as input to the machine learning model 26. The machine learning model is a deep learning model, in particular an encoder-decoder architecture, in this case a U-Net. The U-Net comprises an encoder 34, a decoder 36 and a bottleneck 32. The bottleneck 32 is an interface between the encoder 34 and the decoder 36. Thus, it belongs to the encoder 34 and to the decoder 36. The encoder 34 maps the input into a code, and the decoder 36 maps the code to an output, here the predicted focus-adjusted image 28. The encoder 34 and the decoder 36 are trained to minimize a difference between the predicted focus-adjusted images 28 and corresponding in-focus training images. The encoder 34 gradually reduces the dimensionality of the input image 20 until the bottleneck 32, thereby compressing the information contained in the input image 20 to the most relevant information for the focus-adjustment task. The code generated in the bottleneck 32 is a representation of the input image 20 of lower dimensionality and can, thus, be viewed as a compressed version of the input image 20. The decoder 36 gradually transforms the code in the bottleneck 32 to the output, i.e., to the focus-adjusted image 28. Skip connections 38 allow the decoder 36 to directly access different levels of abstraction of the input image, thereby allowing to preserve small details of the input image 20 in the output.

In a preferred example, additional information is provided as additional input 30 to the machine learning model 26. Additional information can comprise a target focus level, a focus level of the input image (potentially an inexact measurement of the focus level), a design of the photolithography mask, image acquisition information such as an image type, a machine type, an acquisition time, a photon count, a stage speed (from which an expected image blur can be derived), or photolithography mask information such as one or more materials of the photolithography mask, refractive indices, a maximum or minimum feature size, etc., The additional input 30 can be provided in different locations of the machine learning model 26, for example, in the input layer or a hidden layer of a neural network, e.g. of an encoder-decoder architecture, e.g. in the bottleneck.

In a preferred example, the encoder-decoder architecture receives the target focus level as additional input 30 in one of its hidden layers, in particular in one of the decoder 36 layers, preferably in the bottleneck 32. The target focus level can, for example, be incorporated as an additional channel in the bottleneck 32.

As illustrated in FIG. 6, the encoder-decoder architecture in the form of a U-Net receives the focus level as additional input 30 in one of its hidden layers, in particular in one of the encoder 34 layers, preferably in the bottleneck 32. The focus level can, for example, be incorporated as an additional channel in the bottleneck 32.

The target focus level and/or the focus level of the input image 20 can also be incorporated into the input layer, e.g., by concatenating the input image 20 and the target focus level and/or the focus level, or by adding an additional channel to the input image 20 that contains the target focus level everywhere and/or by adding an additional channel to the input image 20 that contains the focus level of the input image 20 everywhere.

An additional input in the form of a scalar value, e.g., a target focus level, a focus level of the input image, an image type, machine type, acquisition time, etc. can, for example, be provided to the machine learning model using an encoding of the scalar value based on sine and cosine functions of different frequencies, similar to positional encodings for x/y coordinates in Transformer architectures. In this way, a very efficient encoding is achieved independent of the length of the additional input. A sequence of sine and cosine functions can, for example, be generated for a scalar value t as follows:

$$S ( τ , 2 i ) = sin \frac{τ}{{n}^{2 i / d}}$$

$$S ( τ , 2 i + 1 ) = cos \frac{τ}{{n}^{2 i + 1 / d}}$$

where i=0, . . . , N is used to map the sine and cosine functions to positions within a sequence, d is the dimension of the output embedding sequence S, N is half of the size of the output embedding space and n is a specified scalar, e.g., 10.000. The resulting sequence S for a scalar τ can, optionally, be transformed into a feature vector, e.g., by a multilayer perceptron. The multilayer perceptron can, for example, have a linear input layer, a Gaussian error linear unit hidden layer and a linear output layer. The resulting feature vector is an encoding of the scalar value t. The encoded scalar can, for example, be concatenated to the input of the input layer or the input of a hidden layer, e.g., the bottleneck, or to the input of a layer of a conditional diffusion model.

Additional inputs 30 can also be provided to the machine learning model using, for example, cross-attention layers. Cross-attention layers transform their input into a new representation called attention-based representation by processing or paying attention to, another data source, here the additional input 30. Compared to CNNs, cross-attention layers are not limited to convolutions within local neighborhoods, but take into account large parts or the whole second source of information. In addition, the weights of the cross-attention layers are not fixed after training, but depend on the second source of information, i.e., on the additional input 30 of the machine learning model.

Thus, cross-attention layers are particularly flexible in taking into account a second source of information, yielding highly accurate prediction results of the machine learning model.

A design image can be provided as additional input 30 in the input layer of a neural network, e.g., of an encoder-decoder architecture such as a U-Net. The rasterized design image can, for example, be combined with the input image 20 via cross-attention layers.

Multiple additional information can be simultaneously provided as additional inputs 30 to the machine learning model 26. For example, the target focus level and the focus level of the input image can both be provided as additional input 30 to the machine learning model 26.

According to an example of the invention illustrated in FIG. 7, a reference image 40 of the object comprising integrated circuit patterns is provided as an additional input 30 to the machine learning model 26, and the machine learning model 26 is trained to adjust at least one of the focus level of the input image 20 and the focus level of the reference image 40 such that the focus levels approximately match. The focus level of the input image 20 can be adjusted to the focus level of the reference image 40, or the focus level of the reference image 40 can be adjusted to the focus level of the input image 20, or the focus level of the input image 20 and the focus level of the reference image 40 can both be adjusted to a different focus level, e.g., to a target focus level or to an optimized focus level with respect to some image quality measure, e.g., an enhanced contrast or an improved detectability of defects. In the latter case, the focus level of the input image 20 and the focus level of the reference image 40 are adjusted using the image quality measure. The image quality measure may, for example, measure an average contrast of the image, e.g., by computing the standard deviation of a histogram of the image. The image quality measure may, for example, measure an average edge contrast of the image, e.g., by computing an average intensity change at edge locations in the image that may be detected using an edge detector. The image quality measure may, for example, measure an amount of high frequencies in Fourier or Wavelet space by computing the amount of frequencies above a threshold frequency. The image quality measure may comprise computing a structural similarity index measure (SSIM) or a signal to noise ratio (SNR). The image quality measure may also be obtained by training a machine learning model to assess the quality of an image. The training data may, for example, comprise images and corresponding scalar quality values indicated by a user, and the machine learning model may be trained to assign a quality value to an input image. To this end, a multilayer perceptron or a support vector machine may, for example, be used. The focus level of the input image 20 and/or the focus level of the reference image 40 and/or a target focus level can be provided as an additional input 30 to the machine learning model as described with respect to FIG. 6. The focus-adjusted input image 28 and the focus-adjusted reference image 42 have matching foci. Thus, they can be compared with higher accuracy, allowing for defect detections of higher accuracy and increased sensitivity. For example, a difference image of the focus-adjusted input image 28 and the focus-adjusted reference image 42 would contain defects and a low noise level, whereas a difference image of the input image 20 and the reference image 40 would yield large differences over the whole image due to the contrast difference and due to different sharpness levels at image edges.

In another example, the machine learning model comprises a conditional diffusion model that sequentially reverts a stochastic process and that is trained to increase a focus level of the input image in each stochastic process step or that is trained to decrease a focus level of the input image in each stochastic process step.

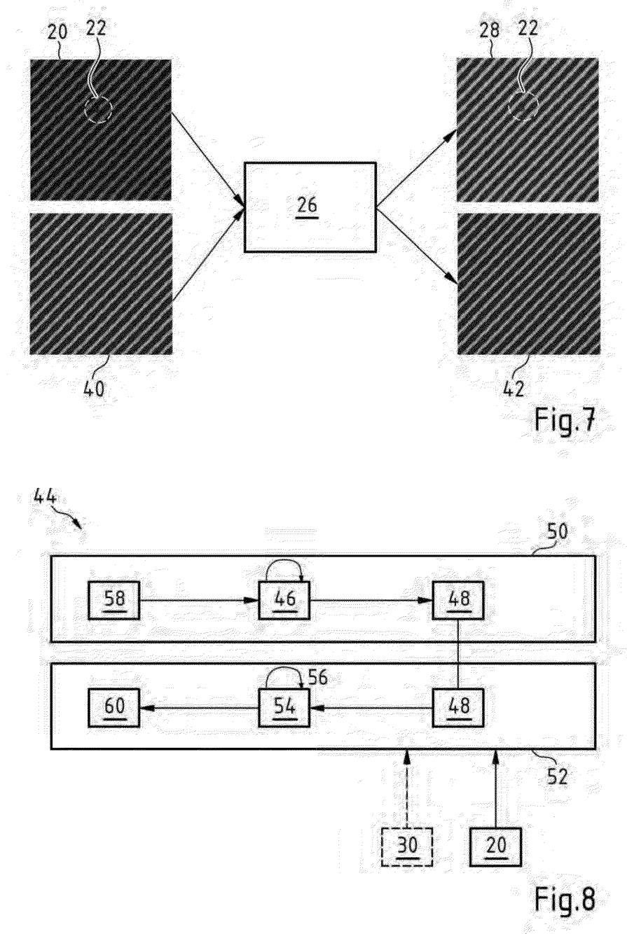

A diffusion model 44 illustrated in FIG. 8 comprises a generative machine learning model that is configured to sequentially revert a stochastic process 50, preferably a diffusion process, using a reverse stochastic process 52. In this case, the stochastic process is a focus level increasing or focus level decreasing process. The diffusion model 44 is configured to learn a distribution of images, here of in-focus images. During training, the diffusion model 44 applies one or more stochastic process steps 46 to an in-focus image 58. This is known as the stochastic process 50, which is used only during training of the diffusion model 44. The stochastic process 50 gradually results in samples 48 that are farther from the learned distribution of in-focus images 58, e.g., “more defocused”. The stochastic process 50 is then reversed in a reverse stochastic process 52 to recover the original in-focus image 58 by sequentially 56 applying a reverse stochastic process step 54 to the sample 48 yielding a generated in-focus image 60. In this way, the diffusion model 44 learns to gradually remove the effect of the stochastic process 50, the defocus, from the samples 48. During inference, only the reverse stochastic process 56 is applied to randomly generated initial samples 48 in order to generate in-focus images 58. Diffusion models are, for example, described in

“Denoising Diffusion Probabilistic Models,” J. Ho, A. Jain, P. Abbeel, 2020, arXiv 2006.11239. Since the invention does not aim at generating arbitrary in-focus images 58, but in-focus images for a specific input image 20, preferably a conditional diffusion model is used that is conditioned on the input image 20. This is accomplished by using the input image 20 as input to the reverse stochastic process 52. Apart from the input image 20, additional information can, optionally, also be provided as a condition to the conditional diffusion model 44, i.e., as additional inputs 30 to the reverse stochastic process 52.

In an example, the machine learning model is trained to remove additional image quality degradations from the input image, for example misalignment, noise or shadow effects. Some of these image quality degradations can be correlated with a defocus of the input image. A specific image quality degradation that is caused by defocus is a focus-specific misalignment of the input image. This focus-specific misalignment can be corrected together with the focus-adjustment and, optionally, further image quality degradations. To obtain a machine learning model for focus adjustment that simultaneously removes additional image quality degradations the training data of the machine learning model can be configured as follows: the training data comprises out-of-focus images and in-focus images, wherein the out-of-focus images contain additional image quality degradations whereas the in-focus images do not contain these additional image quality degradations. When trained with this kind of training data the machine learning model learns to simultaneously remove image quality degradations from the input image with the focus-adjustment without significant computational overhead.

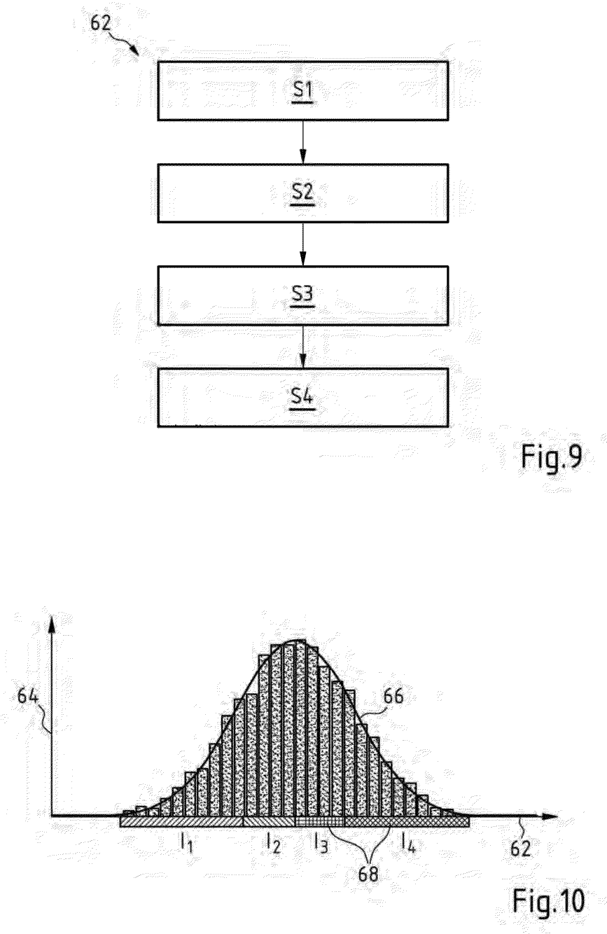

According to a flowchart shown in FIG. 9, instead of training a single machine learning model for adjusting the focus level of an input image, a set of machine learning models is trained. Each machine learning model of the set of machine learning models is trained for a specific focus level interval of the input image. The method 62 for adjusting the focus level of an image of an object comprising integrated circuit patterns comprises: acquiring an input image of an object comprising integrated circuit patterns using an inspection system in a step S1; determining the focus level of the acquired input image in a step S2; selecting a machine learning model from a set of machine learning models using the determined focus level, wherein each machine learning model of the set of machine learning models is trained to adjust the focus level of an input image of an object comprising integrated circuit patterns for an input image of a focus level within a specific focus level interval in a step S3; and applying the selected machine learning model to the input image in a step S4.

The set of machine learning models covers several focus level intervals. These focus level intervals can be of the same size, or they can differ in size. They can be evenly distributed over a predefined interval of expected focus levels of the input image. Alternatively, they can be distributed over the interval of expected focus levels according to the likelihood of the focus levels for occurring in an input image. For example, as illustrated in FIG. 10, a statistic over the frequency 64 of focus levels 62 in input images can be obtained. A probability density function 66, e.g., a normal density function, could optionally be fitted to the statistic, and the focus level intervals 68, e.g., I₁, I₂, I₃, I₄ in FIG. 10, could be defined to occur approximately with the same probability, e.g., by covering approximately the same area under the probability density function. The focus level intervals 68 could, alternatively, be randomly distributed within the interval of expected focus levels, etc. In step S2, the focus level of the acquired input image can, for example, be determined using a measurement method, or it can be specified by a user or obtained from a database, etc. Selecting a machine learning model from the set of machine learning models in step S3 can, for example, comprise selecting the machine learning model whose focus level interval covers the determined focus level of the input image. Alternatively, two, three or more machine learning models could be selected for focus level intervals that are closest to the determined focus level of the input image. After applying these machine learning models to the input image the best result with respect to some image quality measure could be selected as focus-adjusted image.

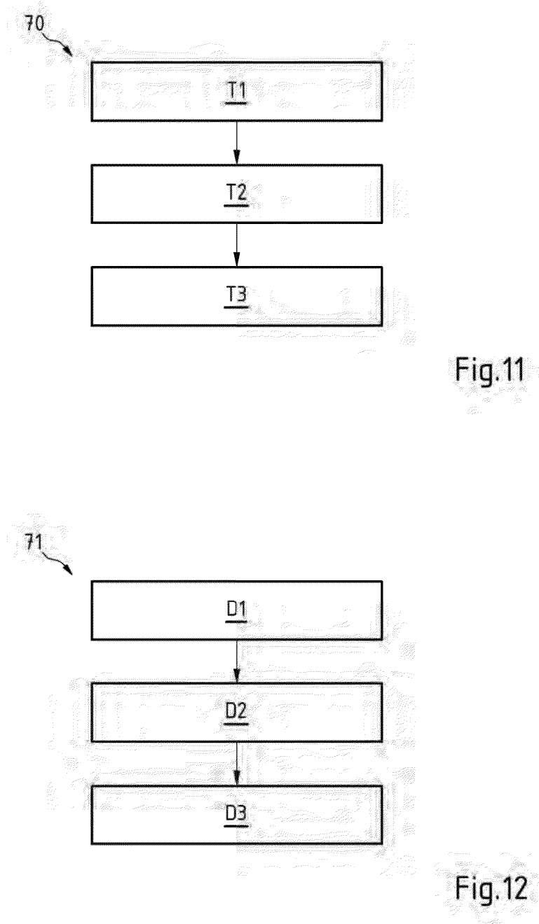

Alternatively, the set of machine learning models can be used to adjust the focus of an input image without determining the focus level of the input image as illustrated in the flowchart in FIG. 11. The method 70 for adjusting the focus level of an image of an object comprising integrated circuit patterns comprises: acquiring an input image of an object comprising integrated circuit patterns using an inspection system in a step T1; applying two or more machine learning models from a set of machine learning models to the acquired input image yielding a set of focus-adjusted images, wherein each machine learning model of the set of machine learning models is trained to adjust the focus level of an input image of an object comprising integrated circuit patterns for an input image of a focus level within a specific focus level interval in a step T2; and selecting a focus-adjusted image from the set of focus-adjusted images using an image quality measure in a step T3.

The two or more applied machine learning models can comprise all machine learning models of the set of machine learning models. Alternatively, the two or more applied machine learning models can be randomly selected from the set of machine learning models. Alternatively, the two or more applied machine learning models can be selected according to some pattern from the set of machine learning models, e.g., a machine learning model can be selected for every second, third, fourth, etc. focus level interval. Alternatively, a fixed number of machine learning models can be selected from the set of machine learning models according to a decreasing likelihood of the corresponding focus level interval, i.e., a decreasing likelihood for a focus level of an input image to fall within the focus level interval, etc.

The machine learning model for adjusting a focus level of an image of an object comprising integrated circuit patterns can be used for defect detection in the image.

FIG. 12 shows a flowchart of a method 71 for detecting defects in an image of an object comprising integrated circuit patterns according to a second embodiment of the invention. The method comprises: acquiring an input image of an object comprising integrated circuit patterns using an inspection system in a step D1; adjusting the focus level of the input image using a method according to any one of the examples or aspects of the first embodiment of the invention in a step D2; and applying a defect detection method to the focus-adjusted input image to detect defects in a step D3.

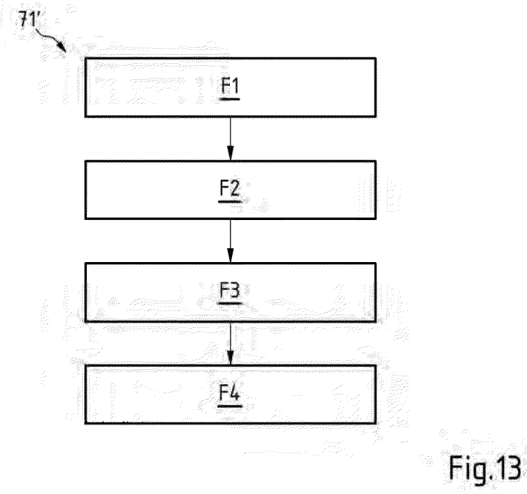

Alternatively, the focus level of a reference image used for defect detection can be adjusted together with the focus level of the input image. FIG. 13 shows a flowchart of a method 71′ for detecting defects in an image of an object comprising integrated circuit patterns according to a second embodiment of the invention. The method comprises: acquiring an input image of an object comprising integrated circuit patterns using an inspection system in a step F1; obtaining a reference image of the object comprising integrated circuit patterns in a step F2; adjusting at least one of the focus level of the input image and the focus level of the reference image such that the focus levels approximately match using a method according to claim 13 or 14 in a step F3; and applying a defect detection method to the focus-adjusted input image and the focus-adjusted reference image in a step F4.

Various defect detection methods for images of objects comprising integrated circuit patterns are known to a person skilled in the art, in particular die-to-die or die-to-database methods. For example, a machine learning model could be trained to detect defects from pairs of the focus-adjusted input image and the focus-adjusted reference image and/or from their difference image. Optionally, the original input image and reference image could be used as additional input to the machine learning model as they may contain additional information. Alternatively, defects could be detected by applying simple thresholds or adaptive thresholds to the difference image, by template matching approaches or filtering approaches.

The training of the machine learning models for focus adjustment in this application can be carried out in different ways.

According to an example, a computer implemented method for training a machine learning model for adjusting the focus level of an image of an object comprising integrated circuit patterns according to a third embodiment of the invention comprises: obtaining training data comprising pairs of out-of-focus images of objects comprising integrated circuit patterns and corresponding in-focus images obtained by adjusting the focus level of the out-of-focus images; and training the machine learning model to adjust the focus level of an input image of an object comprising integrated circuit patterns using the training data. The focus level of the out-of-focus images can, for example, be adjusted by adjusting the position of the stage. Alternatively, the focus level of the out-of-focus images can be adjusted by applying a known image manipulation.

To generate the training data, pairs of out-of-focus images and corresponding in-focus images can be obtained. These pairs can be acquired using different focus settings across one or more objects comprising integrated circuit patterns in the inspection system, e.g., by acquiring an out-of-focus image with any defocus and an in-focus image of the same object at the same location without defocus. The focus levels of the out-of-focus images and/or of the in-focus images can be saved along with the pairs to be used as additional input to the machine learning model. The different focus settings can, for example, be realized by recording images at different focus settings consecutively, i.e., by scanning a swath multiple times at different focus offsets. From each recorded pair of out-of-focus image and in-focus image overlapping sub-images can be extracted, e.g., of size 2048×2048, to be used as training data.

The training data, preferably, comprises different types of integrated circuit patterns, e.g., different types of semiconductor structures or photolithography mask structures such as lines and spaces, contact holes, logic patterns, etc., in order to achieve reliability of the method across different structure types. The training data can comprise out-of-focus images and corresponding in-focus images from different objects, e.g., from different photolithography masks or wafers, or from the same object. Preferably, the out-of-focus images contain integrated circuit patterns at different locations of the objects, e.g., of the photolithography masks or wafers in order to learn spatially dependent defocus options. The out-of-focus images should be acquired or simulated for different focus levels, preferably covering the range of expected focus levels in acquired input images. For example, the distribution of focus levels of the out-of-focus images can reflect the distribution of focus levels in acquired input images. In this way, reliability of the method is achieved for different focus levels of the input image.

The training data can comprise acquired images of objects comprising integrated circuit patterns and/or simulated images of objects comprising integrated circuit patterns. Acquired images are more realistic, e.g., including noise and image quality degradations, but their acquisition is often time-consuming, requires a huge user effort and bears the risk of not covering all relevant patterns, defects, focus levels or image acquisition conditions to achieve a sufficient generalization ability of the machine learning model. Simulated input images are less realistic but are easily generated automatically and quickly at low user effort. In addition, they allow for a systematic and dense generation of images for various ranges of focus levels, integrated circuit pattern types, defect types, image acquisition conditions, image quality degradations, etc. The simulated images can, for example, be obtained using simulations based on physical models such as RCWA or TEA or using simulations based on machine learning models, e.g., diffusion models, or from design data, e.g., from CAD models, for example, by using a generative machine learning model that is conditioned on the design of a photolithography mask. Preferably, the training data comprises both acquired input images and simulated input images to achieve high prediction accuracy.

Preferably, the training data is generated in a systematic way. For example, the same object comprising integrated circuit patterns or section thereof should be used to acquire images at different focus levels to generate out-of-focus images and corresponding in-focus images. Images can be acquired under different focus conditions, for example, by scanning the same object comprising integrated circuit patterns at different focus offsets, or by varying the image sensor acquisition settings, e.g., by mounting some of the image sensors, e.g., TDI sensors, in and out of focus. Images can also be acquired under different focus settings by arranging multiple sensors above or below the focus plane with different fixed specifications in the inspection system.

The training data is split into training data, test data and validation data, e.g., using a splitting ratio of 70%/15%/15%. The splitting of the training data is carried out in a stratified manner to ensure that all structure types and focus levels occur in the training data, test data and validation data. The validation data is used to measure the performance of the machine learning model on unknown data during training. It is used to control the training process and to prevent overfitting. The test data is used to measure the performance of the trained machine learning model.

Using the training data, the machine learning model for adjusting the focus level of an image of an object comprising integrated circuit patterns can be trained. A machine learning model suitable for this task is, for example, an encoder-decoder architecture, e.g., a U-Net, as shown in FIG. 6 or a conditional diffusion model as shown in FIG. 8.

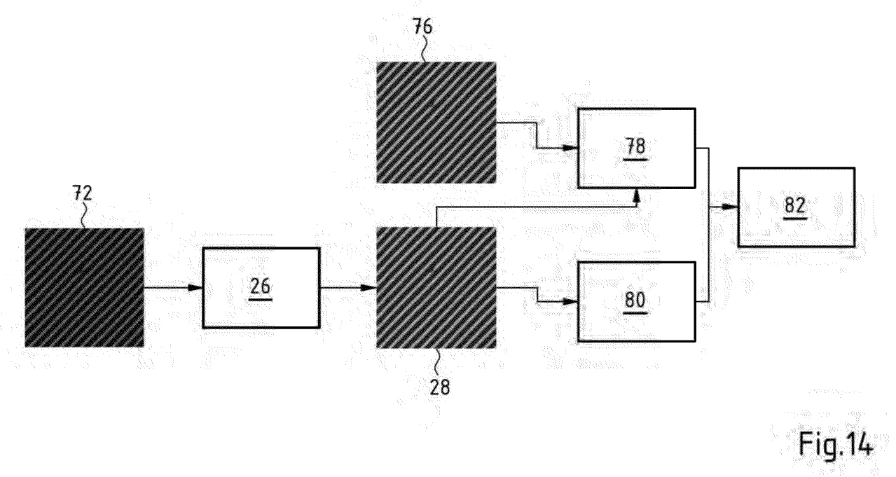

During training of the machine learning model for focus-adjustment a loss function is minimized. The construction of a suitable loss function for training the machine learning model, e.g., an encoder—decoder CNN model, is illustrated in FIG. 14. The loss function 82 can comprise an adjustment loss function 78 and/or an adversarial loss function 80. The adjustment loss function 78 measures the deviation of a predicted focus-adjusted image 28, obtained by applying the machine learning model 26 to an out-of-focus image 72, from the corresponding in-focus image 76. The deviation can, for example, be measured using some norm of the difference of the predicted focus-adjusted image 28 and the in-focus image 76, etc. The adversarial loss function 80 refers to a discriminator loss function of a discriminator that is trained in parallel to discriminate between predicted focus-adjusted images 28 and in-focus images 76. The adversarial loss function 80 measures the distance between a distribution of predicted focus-adjusted images 28 and a distribution of corresponding in-focus images 76. Thus, the discriminator learns to statistically distinguish “fake images” predicted by the machine learning model from “real images” that are acquired.

The training of the machine learning model can be carried out using some optimization algorithm known to a person skilled in the art, in particular the Adam optimization algorithm for neural networks, for a number of epochs, e.g., 500. The hyperparameters of the machine learning model can be optimized using the validation set and some hyperparameter optimization method known to a person skilled in the art.

The machine learning model that is trained using a method described before can be configured according to any of the examples of the first embodiment of the invention described above. For example, the machine learning model can use additional information as additional input, e.g. a design of a photolithography mask, a target focus level, a focus level of an input image, a reference image used as additional input wherein the machine learning model is trained to adjust at least one of the focus level of the input image and the focus level of the reference image such that the focus levels approximately match or match, etc. The additional information can be provided together with the input of the machine learning model, or it can be provided at a later stage of the machine learning model, e.g., in a hidden layer of a neural network. The machine learning model can be trained to remove additional image quality degradations from the input image such as noise, shadow effects or focus-dependent misalignment, etc. To this end, pairs of training data comprising out-of-focus images including these image quality degradations and corresponding in-focus images without these image quality degradations can be used.

In a preferred example, the machine learning model for adjusting the focus level of an image of an object comprising integrated circuit patterns and a subsequent defect detection machine learning model are trained jointly. A joint training means that a single model is trained to perform both tasks simultaneously or subsequently, in this case focus adjustment of the input image followed by defect detection. To accomplish this, the anomaly detection errors can be back-propagated not only into the defect detection machine learning model but also into the focus level adjusting machine learning model. In this way, the focus level adjusting machine learning model can be trained more robustly. Since both tasks are solved together, they can exploit information from each other yielding predictions of higher accuracy.

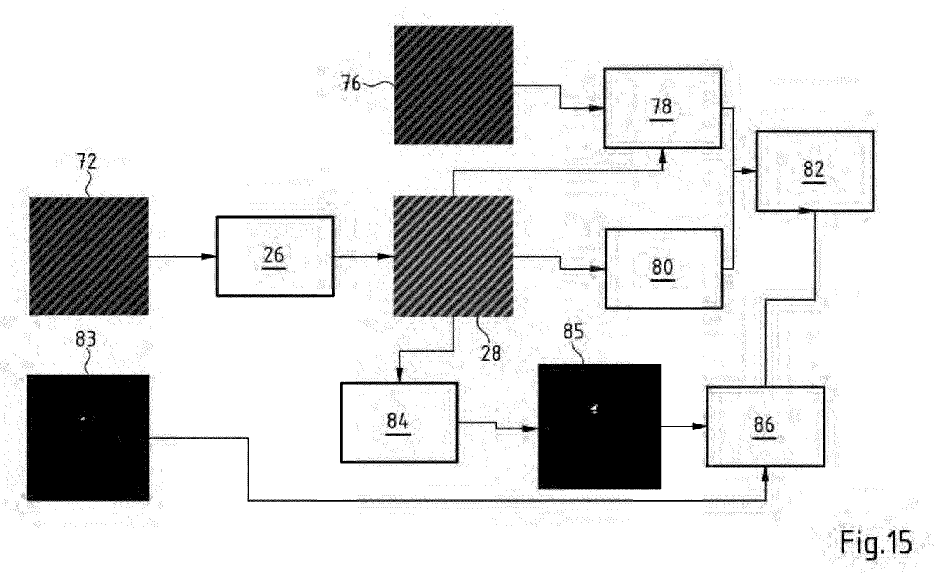

FIG. 15 illustrates the construction of a suitable loss function for jointly training a machine learning model 26 for focus adjustment and a machine learning model 84 for defect detection. The loss function 82 can comprise an adjustment loss function 78 and/or an adversarial loss function 80 and a detection loss function 86. The adjustment loss function 78 and/or the adversarial loss function 80 can be configured as described above.

The detection loss function 86 measures the deviation of a defect prediction 85 from a defect annotation 83. The defect prediction 85 can be obtained by applying the machine learning model 84 for defect detection to the focus-adjusted image 28. Defect annotations 83 can be obtained from user annotations, or they can be generated in case simulated defects are used. The detection loss function 86 can, for example, contain some difference measure of the defect prediction 85 and the defect annotation 83, e.g., a norm of a difference image or an intersection over union measure.

Instead of subsequently applying the machine learning model 84 for defect detection after the machine learning model 26 for focus adjustment, a single machine learning model containing two branches—one for focus adjustment and the other for defect detection—can be used. In this way, the machine learning models 26, 84 share some of the layers at the beginning. After they branch, they process the information in different ways to obtain a focus-adjusted image 28 and a defect prediction 85.

Alternatively, a defect prediction 85 can be obtained by applying the machine learning model 84 for defect detection to the output of an intermediate layer of the machine learning model 26 for focus adjustment. In this way, intermediate feature maps before the final focus-adjustment are used for defect detection. These may provide features that are better suited for defect detection than the final focus-adjusted image 28.

During training and inference, one or more reference images could be additionally used by the machine learning model 26 for focus adjustment and by the machine learning model 84 for defect detection, e.g., a reference image that is used by both the machine learning model 26 for focus adjustment and by the machine learning model 84 for defect detection, e.g., a defect-free in-focus image of an object comprising integrated circuit patterns. Alternatively, different reference images can be used by the machine learning model 26 for focus adjustment and by the machine learning model 84 for defect detection, e.g., an in-focus image of an object comprising integrated circuit patterns as a first reference image for the machine learning model 26 for focus adjustment, and a defect-free image of an object comprising integrated circuit patterns as a second reference image for the machine learning model 84 for defect detection. The second reference image can have a sub-optimal focus, e.g., it can have the same focus as the out-of-focus image 72.

By jointly training the machine learning model for focus adjustment and the machine learning model 84 for defect detection, the machine learning model 26 for focus adjustment can be trained to adjust the focus of an image in a way that is well suited for defect detection and, thus, improves defect detection results. At the same time, the machine learning model 84 for defect detection learns to adapt the defect detection to focus-adjusted images 28. Furthermore, the optimal focus level does not have to be defined in advance for the training data but can be indirectly determined through the detection loss function 86. For example, images that are not perfectly focused might yield better results for defect detection.

Each loss function 82 containing two or more separate loss functions such as the adjustment loss function 78, the adversarial loss function 80 or the detection loss function 86, can contain weighting factors. By using a weighting factor for each of the separate loss functions, the impact of each loss function on the trained machine learning model can be controlled.

Instead of jointly training the machine learning model 26 for focus adjustment and the machine learning model 84 for defect detection, both models can be trained separately as well and can still be used in conjunction.

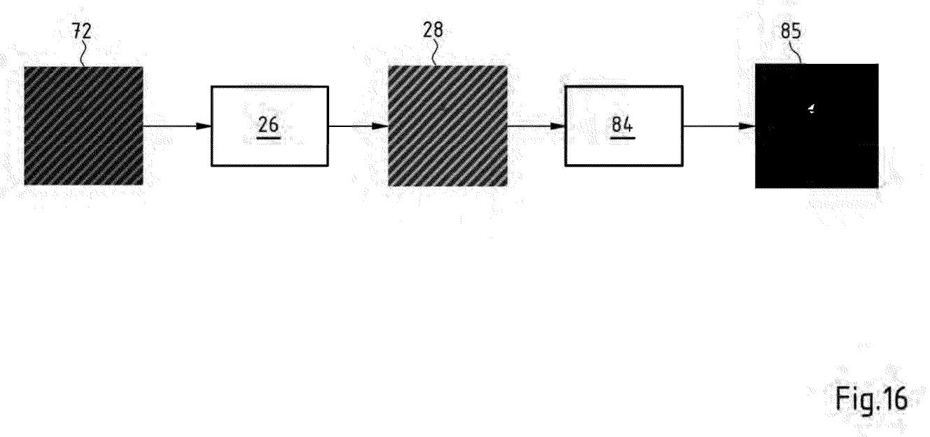

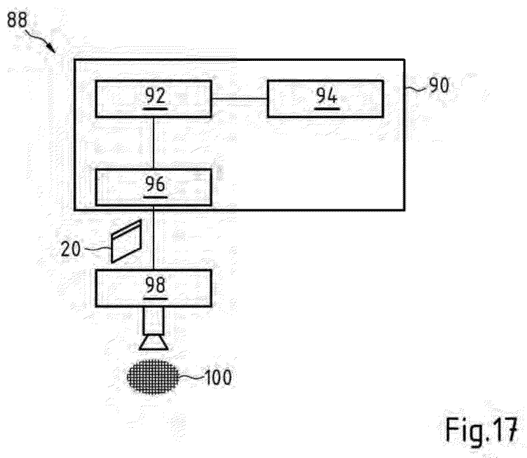

FIG. 16 illustrates the application of a trained machine learning model 26 for focus adjustment and, subsequently, of a trained machine learning model 84 for defect detection to an out-of-focus image 72. The out-of-focus image 72 is transformed to a focus-adjusted image 28 by the trained machine learning model 26 for focus adjustment. Subsequently, a defect prediction 85 is computed from the focus-adjusted image 28 using the trained machine learning model 84 for defect detection. Optionally, one or both of the machine learning models can use a reference image as additional input. A single reference image could be used by both the machine learning model 26 for focus adjustment and by the machine learning model 84 for defect detection, e.g., a defect-free in-focus image of an object comprising integrated circuit patterns. Alternatively, different reference images could be used by the machine learning model 26 for focus adjustment and by the machine learning model 84 for defect detection, e.g., an in-focus image of an object comprising integrated circuit patterns as a first reference image for the machine learning model 26 for focus adjustment, and a defect-free image of an object comprising integrated circuit patterns as a second reference image for the machine learning model 84 for defect detection. The second reference image could have a sub-optimal focus, e.g., it could have the same focus as the out-of-focus image 72.

An inspection system 88 for detecting defects 22 in an object 100 comprising integrated circuit patterns according to a sixth embodiment of the invention is illustrated in FIG. 17. The inspection system 88 comprises: an imaging device 98 configured to provide an image 20 of the object 100 comprising integrated circuit patterns; one or more processing devices 92; one or more machine-readable hardware storage devices 94 comprising instructions that are executable by one or more processing devices 92 to perform operations comprising any one of the methods for detecting defects in an image 20 of an object 100 comprising integrated circuit patterns according to any one of the examples or aspects according the second embodiment of the invention.

The imaging device 98 provides the image 20 to a data analysis device 90 that includes the one or more processing devices 92, the one or more machine-readable hardware storage devices 94, and an interface 96. The one or more processing devices 92 can be implemented, e.g., as a central processing unit (CPU), graphics processing unit (GPU) or tensor processing unit (TPU). The one or more processing devices 92 can receive the image 20 via the interface 96. The one or more processing devices 92 can load program code from a memory, e.g., program code for executing a method for detecting defects 22 according to the second embodiment of the invention as described above. The one or more processing devices 92 can execute the program code.

In some implementations, a system for repairing an object, e.g., a photolithography mask, having integrated circuit patterns can be used to repair the defects in the photolithography mask after the defects are detected using the methods described above. The repair system can be configured to perform an electron beam-induced etching and/or deposition on the mask to repair defects detected by the data analysis device 90. The repair system can include, e.g., an electron source, which emits an electron beam that can be used to perform electron beam-induced etching or deposition on the mask. The repair system can include mechanisms for deflecting, focusing and/or adapting the electron beam. The repair system can be configured such that the electron beam is able to be incident on a defined point of incidence on the mask.

The repair system can include one or more containers for providing one or more deposition gases, which can be guided to the mask via one or more appropriate gas lines. The repair system can also include one or more containers for providing one or more etching gases, which can be provided on the mask via one or more appropriate gas lines. Further, the repair system can include one or more containers for providing one or more additive gases that can be supplied to be added to the one or more deposition gases and/or the one or more etching gases. The repair system can include a user interface to allow an operator to, e.g., operate the repair system and/or read out data. The repair system can also repair other types of objects (e.g., wafers) having integrated circuit patterns.

In some implementations, the apparatus (and its components) can include a light or electromagnetic radiation source to generate light or electromagnetic radiation, an image sensor (e.g., CCD (charged coupled device) or CMOS (complementary metal oxide semiconductor) sensor) having an array of individually addressable sensing elements for capturing images of a sample, and optics (e.g., one or more lenses, mirrors or reflecting surfaces, filters, and/or image stops) to direct and/or focus light or radiation from the one or more light or radiation source to the sample, and from the sample to the image sensor. In some implementations, the apparatus can include a data processor and a storage device. The data processor in the apparatus can be configured to process the data described herein, e.g., according to at least some steps of the methods described herein. The storage device can store at least a part of the instructions comprised in a computer program as described herein, preferably all instructions of the computer program. In some implementations, the apparatus can include one or more computers that include one or more data processors configured to execute one or more programs that include a plurality of instructions according to the principles described above. Each data processor can include one or more processor cores, and each processor core can include logic circuitry for processing data. For example, a data processor can include an arithmetic and logic unit (ALU), a control unit, and various registers. Each data processor can include cache memory. Each data processor can include a system-on-chip (SoC) that includes multiple processor cores, random access memory, graphics processing units, one or more controllers, and one or more communication modules. Each data processor can include millions or billions of transistors.

The processing of data described in this document, such as adjusting the focus level of an image of an object having integrated circuit patterns, detecting defects in an image of an object having integrated circuit patterns, training a machine learning model for adjusting the focus level of an image of an object having integrated circuit patterns, and training a machine learning model for defect detection in an image of an object having integrated circuit patterns, can be carried out using one or more computers, which can include one or more data processors for processing data, one or more storage devices for storing data, and/or one or more computer programs including instructions that when executed by the one or more computers cause the one or more computers to carry out the processes. The one or more computers can include one or more input devices, such as a keyboard, a mouse, a touchpad, and/or a voice command input module, and one or more output devices, such as a display, and/or an audio speaker.

In some implementations, the one or more computing devices can include digital electronic circuitry, computer hardware, firmware, software, or any combination of the above. The features related to processing of data can be implemented in a computer program product tangibly embodied in an information carrier, e.g., in a machine-readable storage device, for execution by a programmable processor; and method steps can be performed by a programmable processor executing a program of instructions to perform functions of the described implementations. Alternatively or in addition, the program instructions can be encoded on a propagated signal that is an artificially generated signal, e.g., a machine-generated electrical, optical, or electromagnetic signal, that is generated to encode information for transmission to suitable receiver apparatus for execution by a programmable processor.

A computer program can be written in any form of programming language, including compiled or interpreted languages, and it can be deployed in any form, including as a stand-alone program or as a module, component, subroutine, or other unit suitable for use in a computing environment.

For example, the one or more computers can be configured to be suitable for the execution of a computer program and can include, by way of example, both general and special purpose microprocessors, and any one or more processors of any kind of digital computer. Generally, a processor will receive instructions and data from a read-only storage area or a random access storage area or both. Elements of a computer system include one or more processors for executing instructions and one or more storage area devices for storing instructions and data. Generally, a computer system will also include, or be operatively coupled to receive data from, or transfer data to, or both, one or more machine-readable storage media, such as hard drives, magnetic disks, solid state drives, magneto-optical disks, or optical disks. Machine-readable storage media suitable for embodying computer program instructions and data include various forms of non-volatile storage area, including by way of example, semiconductor storage devices, e.g., EPROM, EEPROM, flash storage devices, and solid state drives; magnetic disks, e.g., internal hard disks or removable disks; magneto-optical disks; and CD-ROM, DVD-ROM, and/or Blu-ray discs.

In some implementations, the processes described above can be implemented using software for execution on one or more mobile computing devices, one or more local computing devices, and/or one or more remote computing devices (which can be, e.g., cloud computing devices). For instance, the software forms procedures in one or more computer programs that execute on one or more programmed or programmable computer systems, either in the mobile computing devices, local computing devices, or remote computing systems (which may be of various architectures such as distributed, client/server, grid, or cloud), each including at least one processor, at least one data storage system (including volatile and non-volatile memory and/or storage elements), at least one wired or wireless input device or port, and at least one wired or wireless output device or port.

In some implementations, the software may be provided on a medium, such as CD-ROM, DVD-ROM, Blu-ray disc, a solid state drive, or a hard drive, readable by a general or special purpose programmable computer or delivered (encoded in a propagated signal) over a network to the computer where it is executed. The functions can be performed on a special purpose computer, or using special-purpose hardware, such as coprocessors. The software can be implemented in a distributed manner in which different parts of the computation specified by the software are performed by different computers. Each such computer program is preferably stored on or downloaded to a storage media or device (e.g., solid state memory or media, or magnetic or optical media) readable by a general or special purpose programmable computer, for configuring and operating the computer when the storage media or device is read by the computer system to perform the procedures described herein. The inventive system can also be considered to be implemented as a computer-readable storage medium, configured with a computer program, where the storage medium so configured causes a computer system to operate in a specific and predefined manner to perform the functions described herein.

Embodiments, examples and aspects of this invention may be described by the following clauses:
1. A computer implemented method 24 for adjusting the focus level of an image 20 of an object 100 comprising integrated circuit patterns, the method comprising:
   Providing an input image 20 of an object 100 comprising integrated circuit patterns;
   Applying a machine learning model 26 to the input image 20, the machine learning model 26 being trained to adjust a focus level of an input image 20 of an object 100 comprising integrated circuit patterns.
2. The method of clause 1, wherein the machine learning model 26 is trained to adjust the focus level of the input image 20 to a specified target focus level.
3. The method of clause 2, wherein a reference image is additionally provided, wherein the focus level of the reference image 40 is determined, and wherein the target focus level is derived from the focus level of the reference image 40.
4. The method of clause 2 or 3, wherein the target focus level is provided as an additional input 30 to the machine learning model 26.
5. The method of clause 1, wherein the focus level of the input image 20 is adjusted using an image quality measure.
6. The method of any one of the preceding clauses, wherein the focus level of the input image 20 is provided as an additional input 30 to the machine learning model 26.
7. The method of any one of the preceding clauses, wherein a design of a photolithography mask is provided as an additional input 30 to the machine learning model 26.
8. The method of any one of the preceding clauses, wherein the machine learning model 26 is trained to remove additional image quality degradations from the input image 20.
9. The method of any one of the preceding clauses, wherein the machine learning model 26 comprises an encoder-decoder architecture, in particular a U-Net architecture.
10. The method of clause 9, wherein the focus level of the input image 20 is provided as an additional input 30 to the encoder-decoder architecture in one of its hidden layers, in particular in one of the encoder 34 layers, in particular in the bottleneck 11. The method of clause 9 or 10, wherein a target focus level of the input image 20 is provided as an additional input 30 to the encoder-decoder architecture in one of its hidden layers, in particular in one of the decoder 36 layers, in particular in the bottleneck 32.
12. The method of any one of clauses 1 to 9, wherein the machine learning model 26 comprises a conditional diffusion model 44 that sequentially reverts a stochastic process 50 and that is trained to increase a focus level of the input image 20 in each stochastic process step 46 or that is trained to decrease a focus level of the input image 20 in each stochastic process step 46.
13. The method of any one of the preceding clauses, wherein a reference image 40 of the object 100 comprising integrated circuit patterns is provided, and wherein the machine learning model 26 is trained to adjust at least one of the focus level of the input image 20 and the focus level of the reference image 40 such that the focus levels approximately match.
14. The method of clause 13, wherein the focus level of the input image 20 and the focus level of the reference image 40 are adjusted using an image quality measure.
15. A computer implemented method 62 for adjusting the focus level of an image 20 of an object 100 comprising integrated circuit patterns, the method comprising:
   Providing an input image 20 of an object 100 comprising integrated circuit patterns;
   Determining the focus level of the input image 20;
   Selecting a machine learning model 26 from a set of machine learning models 26 using the determined focus level, wherein each machine learning model 26 of the set of machine learning models is trained to adjust the focus level of an input image 20 of an object 100 comprising integrated circuit patterns for an input image 20 of a focus level within a specific focus level interval 68;
   Applying the selected machine learning model 26 to the input image 20.
16. A computer implemented method 70 for adjusting the focus level of an image 20 of an object 100 comprising integrated circuit patterns, the method comprising:
   Providing an input image 20 of an object 100 comprising integrated circuit patterns;
   Applying two or more machine learning models 26 from a set of machine learning models to the input image 20 yielding a set of focus-adjusted images 28, wherein each machine learning model 26 of the set of machine learning models is trained to adjust the focus level of an input image 20 of an object 100 comprising integrated circuit patterns for an input image 20 of a focus level within a specific focus level interval 68;
   Selecting a focus-adjusted image 28 from the set of focus-adjusted images 28 using an image quality measure.
17. The method of any one of the preceding clauses, wherein the input image 20 is acquired using an inspection system 88.
18. A method 71 for detecting defects 22 in an image 20 of an object 100 comprising integrated circuit patterns, the method comprising:
   Providing an input image 20 of an object 100 comprising integrated circuit patterns;
   Adjusting the focus level of the input image 20 using a method according to any one of the preceding clauses;
   Applying a defect detection method to the focus-adjusted input image 28 to detect defects 22.
19. The method of clause 18, wherein the defect detection method comprises a machine learning model 84 for defect detection.
20. A method 71′ for detecting defects 22 in an image 20 of an object 100 comprising integrated circuit patterns, the method comprising:
   Providing an input image 20 of an object 100 comprising integrated circuit patterns;
   Obtaining a reference image 40 of the object 100 comprising integrated circuit patterns;
   Adjusting at least one of the focus level of the input image 20 and the focus level of the reference image 40 such that the focus levels approximately match using a method according to clause 13 or 14;
   Applying a defect detection method to the focus-adjusted input image 28 and the focus-adjusted reference image 42.
21. The method of any one of clauses 18 to 20, wherein the input image 20 is acquired using an inspection system 88.
22. A computer implemented method for training a machine learning model 26 for adjusting the focus level of an image 20 of an object 100 comprising integrated circuit patterns, the method comprising:
   Obtaining training data comprising pairs of out-of-focus images 72 of objects 100 comprising integrated circuit patterns and corresponding in-focus images 76 obtained by adjusting the focus level of the out-of-focus images 72; and
   Training the machine learning model 26 to adjust the focus level of an input image 20 of an object 100 comprising integrated circuit patterns using the training data.
23. The method of clause 22, wherein the machine learning model 26 is trained by minimizing a loss function 82 that comprises the deviation of focus-adjusted images 28 predicted by the machine learning model 26 when presented with out-of-focus images 72 of the training data, from the corresponding in-focus images 76 of the training data.
24. The method of clause 22 or 23, wherein the machine learning model 26 is trained by minimizing a loss function 82 that comprises an adversarial loss function 80 that measures the distance between a distribution of focus-adjusted images 28 predicted by the machine learning model 26 when presented with out-of-focus images 72 of the training data, and a distribution of the corresponding in-focus images 76.
25. The method of any one of clauses 22 to 24, wherein the machine learning model 26 for adjusting the focus level of an image 20 of an object 100 comprising integrated circuit patterns is configured according to any one of clauses 1 to 17.
26. A computer implemented method for training a machine learning model 26 for adjusting the focus level of an image 20 of an object 100 comprising integrated circuit patterns and a machine learning model 84 for defect detection in an image 20 of an object 100 comprising integrated circuit patterns according to clause 19, wherein a joint loss function is used to train the machine learning model 26 for adjusting the focus level of an image 20 and the machine learning model 84 for defect detection jointly.
27. A computer-readable medium, on which a computer program executable by a computing device is stored, the computer program comprising code for executing a method of any one of clauses 22 to 26.
28. A computer program product comprising instructions which, when the program is executed by a computer, cause the computer to carry out a method of any one of clauses 22 to 26.
29. An inspection system 88 for detecting defects 22 in an object 100 comprising integrated circuit patterns, the system comprising:
   an imaging device 98 configured to provide an image 20 of the object 100 comprising integrated circuit patterns;
   one or more processing devices 92;
   one or more machine-readable hardware storage devices 94 comprising instructions that are executable by one or more processing devices 92 to perform operations comprising any one of the methods for detecting defects 22 in an image 20 of an object 100 comprising integrated circuit patterns according to any one of clauses 18 to 21.

Reference throughout this specification to “an embodiment” or “an example” or “an aspect” means that a particular feature, structure or characteristic described in connection with the embodiment, example or aspect is included in at least one embodiment, example or aspect. Thus, appearances of the phrases “according to an embodiment”, “according to an example” or “according to an aspect” in various places throughout this specification are not necessarily all referring to the same embodiment, example or aspect, but may refer to different embodiments, examples, or aspects. Furthermore, the particular features or characteristics may be combined in any suitable manner, as would be apparent to one of ordinary skill in the art from this disclosure, in one or more embodiments.

Furthermore, while some embodiments, examples or aspects described herein include some but not other features included in other embodiments, examples or aspects combinations of features of different embodiments, examples or aspects are meant to be within the scope of the claims, and form different embodiments, as would be understood by those skilled in the art.

In summary, the invention relates to a method for adjusting the focus level of an image of an object comprising integrated circuit patterns, the method comprising: acquiring an input image 20 of an object comprising integrated circuit patterns using an inspection system; and applying a machine learning model 26 to the input image 20, the machine learning model 26 being trained to adjust a focus level of an input image 20 of an object comprising integrated circuit patterns. The invention also relates to methods for defect 22 detection making use of such methods, to methods for training a corresponding machine learning model and to a corresponding system for defect 22 detection.

### REFERENCE NUMBER LIST

10, 10′ Photolithography system
12 Radiation source
14 Photolithography mask
16 Illumination optics
17 Projection optics
18 Wafer plane
19 Projection section
20 Image
22 Defect
24 Method
26 Machine learning model
28 Focus-adjusted image
30 Additional input
32 Bottleneck
34 Encoder
36 Decoder
38 Skip connections
40 Reference image
42 Focus-adjusted reference image
44 Diffusion model
46 Stochastic process step
48 Sample
50 Stochastic process
52 Reverse stochastic process
54 Reverse stochastic process step
56 Sequence
58 In-focus image
60 Generated in-focus image
62 Focus level
64 Frequency
66 Probability density function
68 Focus level interval
70 Computer implemented method
71, 71′ Method
72 Out-of-focus image
76 In-focus image
78 Adjustment loss function
80 Adversarial loss function
82 Loss function
83 Defect annotation
84 Machine learning model for defect detection
85 Defect prediction
86 Detection loss function
88 Inspection system
90 Data analysis device
92 Processing device
94 Hardware storage device
96 Interface
98 Imaging device
100 Object

What is claimed is:

1. A computer implemented method for adjusting the focus level of an image of an object comprising integrated circuit patterns, the method comprising:
providing an input image of an object comprising integrated circuit patterns; and
applying a machine learning model to the input image, the machine learning model being trained to adjust a focus level of an input image of an object comprising integrated circuit patterns.

2. The method of claim 1, wherein the machine learning model is trained to adjust the focus level of the input image to a specified target focus level.

3. The method of claim 2, wherein a reference image is additionally provided, wherein the focus level of the reference image is determined, and wherein the target focus level is derived from the focus level of the reference image.

4. The method of claim 2, wherein the target focus level is provided as an additional input to the machine learning model.

5. The method of claim 1, wherein the focus level of the input image is adjusted using an image quality measure.

6. The method of claim 1, wherein the focus level of the input image is provided as an additional input to the machine learning model.

7. The method of claim 1, wherein a design of a photolithography mask is provided as an additional input to the machine learning model.

8. The method of claim 1, wherein the machine learning model is trained to remove additional image quality degradations from the input image.

9. The method of claim 1, wherein the machine learning model comprises an encoder-decoder architecture.

10. The method of claim 9, wherein the focus level of the input image is provided as an additional input to the encoder-decoder architecture in one of its hidden layers.

11. The method of claim 9, wherein a target focus level of the input image is provided as an additional input to the encoder-decoder architecture in one of its hidden layers.

12. The method of claim 1, wherein the machine learning model comprises a conditional diffusion model that sequentially reverts a stochastic process and that is trained to increase a focus level of the input image in each stochastic process step or that is trained to decrease a focus level of the input image in each stochastic process step.

13. The method of claim 1, wherein a reference image of the object comprising integrated circuit patterns is provided, and wherein the machine learning model is trained to adjust at least one of the focus level of the input image and the focus level of the reference image such that the focus levels approximately match.

14. The method of claim 13, wherein the focus level of the input image and the focus level of the reference image are adjusted using an image quality measure.

15. A computer implemented method for adjusting the focus level of an image of an object comprising integrated circuit patterns, the method comprising:
providing an input image of an object comprising integrated circuit patterns;
determining the focus level of the input image;
selecting a machine learning model from a set of machine learning models using the determined focus level, wherein each machine learning model of the set of machine learning models is trained to adjust the focus level of an input image of an object comprising integrated circuit patterns for an input image of a focus level within a specific focus level interval; and
applying the selected machine learning model to the input image.

16. A computer implemented method for adjusting the focus level of an image of an object comprising integrated circuit patterns, the method comprising:
providing an input image of an object comprising integrated circuit patterns;
applying two or more machine learning models from a set of machine learning models to the input image yielding a set of focus-adjusted images, wherein each machine learning model of the set of machine learning models is trained to adjust the focus level of an input image of an object comprising integrated circuit patterns for an input image of a focus level within a specific focus level interval; and
selecting a focus-adjusted image from the set of focus-adjusted images using an image quality measure.

17. The method of claim 1, wherein the input image is acquired using an inspection system.

18. A method for detecting defects in an image of an object comprising integrated circuit patterns, the method comprising:
providing an input image of an object comprising integrated circuit patterns;
adjusting the focus level of the input image using a method according to claim 1; and
applying a defect detection method to the focus-adjusted input image to detect defects.

19. The method of claim 18, wherein the defect detection method comprises a machine learning model for defect detection.

20. A method for detecting defects in an image of an object comprising integrated circuit patterns, the method comprising:
providing an input image of an object comprising integrated circuit patterns;
obtaining a reference image of the object comprising integrated circuit patterns;
adjusting at least one of the focus level of the input image and the focus level of the reference image such that the focus levels approximately match using a method of claim 13; and
applying a defect detection method to the focus-adjusted input image and the focus-adjusted reference image.

21. The method of claim 18, wherein the input image is acquired using an inspection system.

22. A computer implemented method for training a machine learning model for adjusting the focus level of an image of an object comprising integrated circuit patterns, the method comprising:
obtaining training data comprising pairs of out-of-focus images of objects comprising integrated circuit patterns and corresponding in-focus images obtained by adjusting the focus level of the out-of-focus images; and
training the machine learning model to adjust the focus level of an input image of an object comprising integrated circuit patterns using the training data.

23. The method of claim 22, wherein the machine learning model is trained by minimizing a loss function that comprises the deviation of focus-adjusted images predicted by the machine learning model when presented with out-of-focus images of the training data, from the corresponding in-focus images of the training data.

24. The method of claim 22, wherein the machine learning model is trained by minimizing a loss function that comprises an adversarial loss function that measures the distance between a distribution of focus-adjusted images predicted by the machine learning model when presented with out-of-focus images of the training data, and a distribution of the corresponding in-focus images.

25. The method of claim 22, wherein the machine learning model for adjusting the focus level of an image of an object comprising integrated circuit patterns is configured to be used in a second computer implemented method for adjusting the focus level of an image of an object comprising integrated circuit patterns, the second computer implemented method comprising:
providing an input image of an object comprising integrated circuit patterns; and
applying a machine learning model to the input image, the machine learning model being trained to adjust a focus level of an input image of an object comprising integrated circuit patterns.

26. A computer implemented method for training a machine learning model for adjusting the focus level of an image of an object comprising integrated circuit patterns and a machine learning model for defect detection in an image of an object comprising integrated circuit patterns according to claim 19, wherein a joint loss function is used to train the machine learning model for adjusting the focus level of an image and the machine learning model for defect detection jointly.

27. A computer-readable medium, on which a computer program executable by a computing device is stored, the computer program comprising code for executing a method of claim 22.

28. A computer program product comprising instructions which, when the program is executed by a computer, cause the computer to carry out a method of claim 22.

29. An inspection system for detecting defects in an object comprising integrated circuit patterns, the system comprising:
an imaging device configured to provide an image of the object comprising integrated circuit patterns;
one or more processing devices;
one or more machine-readable hardware storage devices comprising instructions that are executable by one or more processing devices to perform operations comprising the method for detecting defects in an image of an object comprising integrated circuit patterns according to claim 18.
